(19) United States
(12) Patent Application Publication
(10) Pub. No.: US 2010/0039055 A1
(43) Pub. Date: Feb. 18, 2010

(54) TEMPERATURE CONTROL OF MOTOR

(76) Inventor: Young-Chun Jeung, Cypress, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/191,982

(22) Filed: Aug. 14, 2008

(51) Int. Cl. H02P 6/00; H02P 6/16

(52) U.S. Cl. 318/400.08; 318/400.35

(57) ABSTRACT

Some embodiments of the present disclosure provide a brushless motor configured to sense the temperature of the motor and control the operation of the motor. The motor is configured to lower the current generation in a power switching circuit and lower the temperature within the power switching circuit without stopping the operation of the motor. The brushless motor comprises a rotor, a stator comprising windings, a power switching circuit configured to supply an electric current to the windings, a temperature sensor placed on or in the vicinity of the power switching circuit and configured to sense or ascertain temperature of the power switching circuit, and a controller configured to receive a temperature input from the temperature sensor, select a mode of operation of the motor based on the temperature input, and generates a pulse width modulation (PWM) signal corresponding to the selected mode of operation. The present disclosure also provides a method of running a brushless motor with temperature control. The method comprises providing a motor, which comprises a rotor, a stator with windings, and a power switching circuit configured to supply an electric current to the windings, sensing or ascertain temperature of the power switching circuit, selecting a mode of operation of the motor based on the sensed or ascertained temperature, and generating a pulse width modulation (PWM) signal corresponding to the selected mode of operation.

### BACKGROUND

1. Field

The present disclosure relates to a temperature control of an electrical brushless motor.

2. Description of the Related Technology

Brushless motors are widely used for driving a blower or a fan of an HVAC (heating, ventilation, and air conditioning) has been widely used. During the operation of the motor, heat is generated in a power switch circuit that provide current is to the windings. Overheating of the power switch can cause malfunction of the motor or cause mechanical damage to the motor.

### SUMMARY

These and other problems are solved by a brushless motor configured to sense the temperature of the motor and control the operation of the motor. The motor is configured to lower the current generation in a power switch and lower the temperature within the power switch without stopping the operation of the motor.

In one embodiment, the brushless motor comprises a rotor, a stator comprising windings, a power switching circuit configured to supply an electric current to the windings, a temperature sensor placed on or in the vicinity of the power switching circuit and configured to sense or ascertain temperature of the power switch, and a controller. The controller comprises a micro processor, a logic chip, and gate drives and is configured to receive a temperature input from the temperature sensor, select a mode of operation of the motor based on the temperature input, and generates a pulse width modulation (PWM) signal corresponding to the selected mode of operation. The brushless motor further comprises a power supply supplying power to the motor.

In one embodiment, the mode of operation of the brushless motor allows the motor to operate at reduced power. In selecting the mode of operation, the controller is configured to compare the temperature input with at least one reference temperature, wherein at least one reference temperature is assigned to one of a plurality of modes of operation. A mode of operation is selected when the temperature input is above a reference temperature that is assigned to the mode of operation. In one embodiment the temperature input to the controller is substantially constant and in other embodiments the temperature input to the controller is variable.

In another embodiment, the power switching circuit is connected with the controller and the power supply, wherein the power switching circuit is configured to supply electrical current to the windings. The controller is configured to generate a PWM signal corresponding to the selected mode of operation and sends the signal to the power switching circuit (power switch), wherein the PWM signal controls the current output from the power switching circuit to the windings of the motor. A reduction of current supplied by the power switch reduces temperature of the power switch.

In one embodiment, the mode of operation comprises stopping the motor. The brushless motor may further comprise a thermistor, a thermostat, or a logic signal stop configured to stop the operation of the motor if the temperature is above a reference temperature.

One embodiment provides a method of running a brushless motor with temperature control. The method comprises providing a motor, which comprises a rotor, a stator with windings, and a power switch configured to supply an electric current to the windings, sensing or ascertain temperature of the power switch, selecting a mode of operation of the motor based on the sensed or ascertained temperature, and generating a pulse width modulation (PWM) signal corresponding to the selected mode of operation.

In one embodiment the selecting of the mode of operation comprises comparing the temperature with at least one reference temperature, wherein at least one reference temperature is assigned to one of a plurality of modes of operation. A mode of operation is selected when the temperature input is above a reference temperature that is assigned to the mode of operation.

In another embodiment the PWM signal from the controller is provided to the power switch and configured to control the current supplied by the power switching circuit to the windings. A reduction of current supplied by the power switch reduces temperature of the power switching circuit.

### BRIEF DESCRIPTION OF THE DRAWINGS

FIG. 1 is a flow chart of an operation of the brushless motor with temperature control.

FIG. 2 is a block diagram.

### DETAILED DESCRIPTION OF THE EMBODIMENTS

Embodiments of the present invention provide a temperature sensing and control system of an electric brushless motor. Even though a brushless motor is configured to operate at a certain speed, depending on the application of the motor it maybe necessary to lower the current in order to avoid overheating. One embodiment provides a system and a method for sensing the temperature and controlling the operation of the motor to prevent overheating of the motor. The brushless motor can be a DC motor in one embodiment and an AC motor in another embodiment.

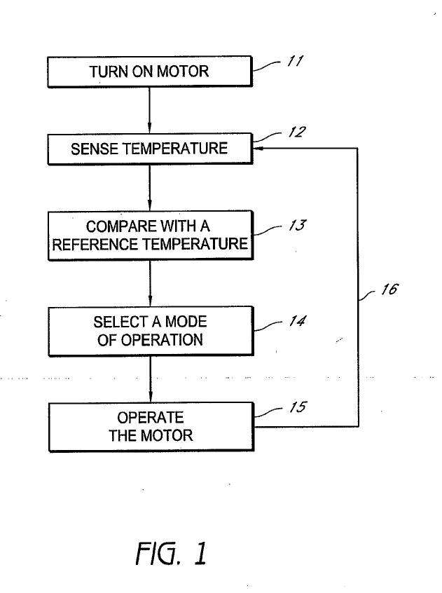

An illustration of an embodiment for the process of operation of the system is shown in FIG. 1. First, power is provided to the motor in process block 11. The motor starts its operation and a rotor of the motor is driven to rotate as current is supplied to the winding of a stator of the motor. The permanent magnets of the rotor and the electromagnetic fields created by the windings in the stator interact with each other to make the rotor rotate. The motor comprises a power switch (power switching circuit) that outputs the necessary current needed to rotate the rotor. Heat is generated in the power switch as current is switched during the operation of the motor. The operating temperature is sensed at or around the power switch in process block 12. After the temperature has been sensed, the sensed data is provided to a motor control system, such as, for example a microprocessor in the control system. The temperature signal sent to the microprocessor is compared with at least one of pre-determined reference temperatures in process block 13, wherein at least one reference temperature is assigned to one of a plurality of mode of operations that determine the operating conditions of the motor. The mode of operation is selected in process block 14 after the comparison of the sensed and one of the reference temperatures. If the operating temperature of the motor is equal to or exceeds the highest reference temperature value, the controller sends a signal to slow down or stop the motor. The signal is provided, to the power switching circuit and the current output of the power switching circuit is changed. This temperature sensing and control of the motor is configured to prevent damage of the motor and, thus, prevent an interruption in the motor application due to overheating. The different modes of operation determine the operational speed of the motor and the motor is operated accordingly in process block 15. In other embodiments the operational speed of the motor can be determined as a function of the sensed temperature. During the operation of the motor, the process of temperature detection is repeated as a feedback loop as shown in 16. The time interval of temperature sensing is configured to be substantially constant. However, it can be monitored in time increments that are sufficient to avoid any prolonged overheating.

An example of how the mode of operation of the motor is selected is as follows. In one embodiment at least one pre-determined reference temperature is present and at least one reference temperature is assigned to a mode of operation. The mode of operation determines the current to be supplied to the power switch and consequently the rotational speed of the rotor of the motor. In cases with multiple reference temperatures, the sensed temperature signal is compared with available reference temperatures. If the sensed temperature is equal to or higher than the highest reference temperature, the motor operates at the mode of operation assigned to the highest reference temperatures. In other conditions the comparison is configured to determine if the sensed temperature lies between a pair of reference temperatures. If the sensed temperature is above one of reference temperatures and below the next highest reference temperature, the motor operates at the mode of operation assign to the reference temperature that is lower between the two reference temperatures. The reference temperature may comprise 0° C. In cases with only one reference temperature, the motor operates at one mode of operation above the reference temperature and another mode of operation below the reference temperature.

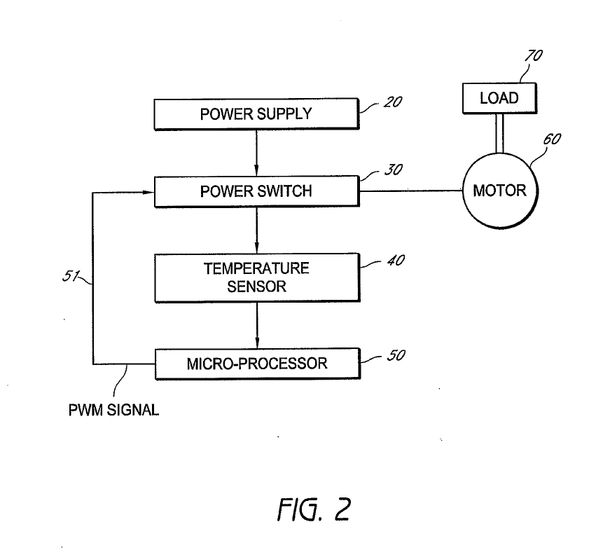

FIG. 2 is a block diagram of the components of an embodiment of the present disclosure. Power supply 20 is configured to provide the power needed to operate the motor. It provides power to rotate the rotor of the motor as well as to operate the controller of the motor that uses logic level power. The power supply 20 provides power to a power switch (power switching circuit) 30 that outputs current to the windings 60 of the motor. The power switch 30 receives the necessary power to supply electric current to the windings 60 of the motor from the power supply 20. The power switch 30 also receives PWM (Pulse Width Modulation) control signals 51 from the microprocessor 50 of the motor controller system. The PWM signals 51 are configured to control the output of the current from the power switch 30 to the windings 60. The difference in widths of the PWM signals determines the amount of current output of power switch 30. The amount current supplied to the windings 60 determines the rotational speed of the rotor of the motor. As more current is supplied, the rotor rotates at a higher speed. As a result, the current supplied to the windings 60 is transformed to mechanical work of the rotor and work is performed on a load 70 that is provided to the motor.

The temperature of the motor during motor operation is detected by a temperature detection sensor 40 and this is sent as a signal to the microprocessor 50 of the controller. The temperature of the motor is based at least in part of the temperature of the power switching circuit 30 as this is typically where much of the heat is generated inside the brushless motor. The temperature sensor 40 is configured to be placed in a position to sense the temperature variation of the power switch 30. The sensor 40 may be mounted on or near the power switch 30. The temperature of the power switch 30 may be affected by the temperature of the external surroundings of the motor. If the motor is positioned in a place exposed to external heat, the heat sensed by the temperature sensor 40 is higher than the temperature of the power switch 30 alone. In some embodiments of the disclosure, the temperature sensor 40 may be a transistor, a thermistor, or etc. for outputting a voltage signal proportional to a temperature

In one embodiment, when the temperature value of the motor detected by the temperature detection sensor is equal or above a pre-determined temperature value, the microprocessor sends a signal (PWM signal 51) to reduce the rotation speed or the output of the motor to from about 20% to about 99% of its maximum capability. Further, when the temperature value of the motor detected by the temperature detection sensor returns below a reference temperature, the microprocessor gradually increases the rotational speed or the output of the motor to its maximum pre-determined speed or output. The microprocessor may send a signal to an external display unit to output the variety of operating conditions of the motor including the operating temperature.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A brushless motor, comprising:
a rotor;
a stator comprising windings;
a power switching circuit configured to supply an electric current to the windings;
a temperature sensor placed on or in the vicinity of the power switching circuit and configured to sense a temperature of the power switching circuit; and
a controller configured to receive a temperature input from the temperature sensor, select a mode of operation of the motor based on the temperature input, and generates a pulse width modulation (PWM) signal corresponding to the selected mode of operation.

2. The brushless motor of claim 1, wherein the controller comprises at least one of a micro processor, a logic chip, and gate drives.

3. The brushless motor of claim 1, further comprising a power supply supplying power to the motor.

4. The brushless motor of claim 1, wherein the mode of operation comprises operation at reduced speed.

5. The brushless motor of claim 1, wherein the controller is configured to compare the temperature input with at least one reference temperature.

6. The brushless motor of claim 5, wherein at least one reference temperature is assigned to one of a plurality of mode of operation.

7. The brushless motor of claim 6, wherein a mode of operation is selected when the temperature input is above a reference temperature that is assigned to the mode of operation.

8. The brushless motor of claim 1, wherein the power switching circuit is connected with the controller and the power supply, wherein the power switching circuit is configured to supply electrical current to the windings.

9. The brushless motor of claim 8, wherein the controller is configured to generate a PWM signal corresponding to the selected mode of operation and sends the signal to the power switching circuit, wherein the PWM signal controls the current output from the power switching circuit to the windings of the motor.

10. The brushless motor of claim 9, wherein a reduction of current supplied by the power switching circuit reduces temperature of the power switching circuit.

11. The brushless motor of claim 1, wherein the temperature input to the controller is substantially constant.

12. The brushless motor of claim 1, wherein the temperature input to the controller is periodical.

13. The brushless motor of claim 1, wherein the mode of operation comprises stopping the motor.

14. The brushless motor of claim 13, further comprising a thermistor, a thermostat, or a logic signal stop configured to stop the operation of the motor if the temperature input is above a reference temperature.

15. A method of running a brushless motor, the method comprising:
providing a motor, which comprises a rotor, a stator with windings, and a power switching circuit configured to supply an electric current to the windings;
sensing a temperature of the power switching circuit;
selecting a mode of operation of the motor based on the sensed or ascertained temperature; and
generating a pulse width modulation (PWM) signal corresponding to the selected mode of operation.

16. The method of claim 15, wherein the mode of operation comprises operation at reduced speed.

17. The method of claim 15, wherein selecting comprises comparing the temperature with at least one reference temperature.

18. The method of claim 17, wherein at least one reference temperature is assigned to one of a plurality of mode of operation.

19. The method of claim 18, wherein a mode of operation is selected when the temperature input is above a reference temperature that is assigned to the mode of operation.

20. The method of claim 15, wherein the PWM signal from the controller is inputted to the power switching circuit and configured to control the current supplied by the power switching circuit to the windings.

21. The method of claim 20, wherein a reduction of current supplied by the power switching circuit reduces temperature of the power switching circuit.
